(19) United States
(12) Patent Application Publication
(10) Pub. No.: US 2008/0005967 A1
(43) Pub. Date: Jan. 10, 2008

(54) Stow-away pet barrier for use in a motor vehicle

(76) Inventors: Douglas M. Johnson, Lindenhurst, IL (US); Kristine Johnson, Lindenhurst, IL (US)

Correspondence Address: SUNG I. OH, PROFESSIONAL LAW CORPORATION, 710 QUAIL VALLEY LANE, WEST COVINA, CA, 91791, US

(21) Appl. No.: 11/481,757

(22) Filed: Jul. 6, 2006

(51) Int. Cl. E05B 65/04

(52) U.S. Cl. 49/61

(57) ABSTRACT

A pet barrier that is placed in a motor vehicle to divide a portion of the interior of the vehicle from the remainder of the interior of the vehicle. The barrier can be removed when not used but can be quickly set up when needed. The barrier includes a telescoping support pole that has screens attached thereto. When the support pole is placed in the vehicle, such as by frictionally engaging the ends of the pole against the interior sides of the vehicle, the screens will divide the compartment so a pet can be confined behind the screens.

### TECHNICAL FIELD OF THE INVENTION

The present invention relates to the general art of motor vehicles, and to the particular field of accessories for use in motor vehicles to accommodate animals, such as pets or the like.

### BACKGROUND OF THE INVENTION

Pets are an eternal part of life in America and other countries, and generate interest that ranges from mild to obsessive. Many people take their pets with them in their vehicles, and especially in the case of large dogs, the pets can be not only destructive to the interior of the vehicle, but a genuine hazard if they tend to jump upon the driver, interfering with his driving and distracting him from the road.

Accordingly, there is a reoccurring need to transport medium to large pets, such as dogs, in an automotive vehicle, either the pet owner's vehicle or a vehicle owned by someone else, and because of the above-mentioned hazard of a pet jumping into the driver's area, this need presents a continuing problem confronting these pet owners as to a simple, effective method for temporarily containing or restricting the pets during transportation, without having the pet either disrupt the driver and passengers or soil or damage the seating portions of the vehicle.

In many situations, cages and restraining straps are unsuitable due to space limitations in the vehicle, expense of a cage, or time and effort required installing and removing the cage or restraining straps. Some examples of non-cage, non-strap solutions to the problem are a portable barrier to prevent the pet from exiting the vehicle through an open window and an adjustable barrier mounted from floor to ceiling, extending transversely across the width of the vehicle.

It is also known to provide a barrier in a motor vehicle which extends from the floor to the ceiling of the vehicle cabin in order to partition the luggage/cargo area from the remainder of the cabin. Typically, such a barrier is installed behind the rearmost seats to allow a pet, such as a dog, to travel in the luggage/cargo area safely. In consequence, these barriers are typically referred to as dog guards.

Currently available barriers used as dog guards generally are arranged for stability to be substantially perpendicular to the vehicle floor and ceiling, and are secured by pressure on the floor and ceiling. Unfortunately, many vehicles incorporate an inclined rear bench seat which has a backrest at an angle, for passenger comfort. Thus, a perpendicular barrier will engage the top edge of a rear bench seat create wasted space between the point where the barrier engages the cargo/luggage area floor and the back of the rear seat.

Therefore, there is a need for a simple, portable barrier that will restrict pets to a particular portion of a vehicle, generally the rearmost portion of the vehicle.

Still further, if during use of a barrier, the driver or a passenger in the front seat must reach behind the seat into the rear area of the vehicle for some reason, the barriers known to the inventor must be nearly dismantled. This will be an annoyance at best, and present a hazard at worst.

Therefore, there is a need for a simple barrier that can be easily moved between a use position and a stored position.

### SUMMARY OF THE INVENTION

The above-discussed disadvantages of the prior art are overcome by a barrier that is placed in a motor vehicle to divide a portion of the interior of the vehicle from the remainder of the vehicle interior. The barrier can be removed when not used but can be quickly set up when needed. The barrier includes a telescoping support pole that has screens attached thereto. When the support pole is placed in the vehicle, such as by frictionally engaging the ends of the pole against the interior sides of the vehicle, the screens will divide the compartment so a pet can be confined behind the screens.

Using the pet barrier embodying the present invention will permit the easy and quick placement of a pet barrier to prevent a pet from jumping into the area of a driver of a motor vehicle. When no pet is being confined, the barrier can be easily stored in an out-of-the way location; and when the barrier is needed, the barrier can be quickly and easily moved from a stored position into a use position. The barrier will thus not interfere with normal operation of the vehicle yet will be readily available when needed. Still further, if a driver must reach behind him for some reason, the barrier can be easily moved out of the way.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a pet barrier embodying the present invention.

FIG. 2 is a view taken along line 2-2 of FIG. 1.

FIG. 3 shows an alternative form of the support rod included with the pet barrier of the present invention.

FIG. 4 shows an alternative form of the pet barrier of the present invention.

FIG. 5 shows an end view of a grommet.

FIG. 6 shows an additional screen that can be mounted adjacent to the floor of a vehicle.

FIG. 7 shows a pet barrier system mounted in a vehicle.

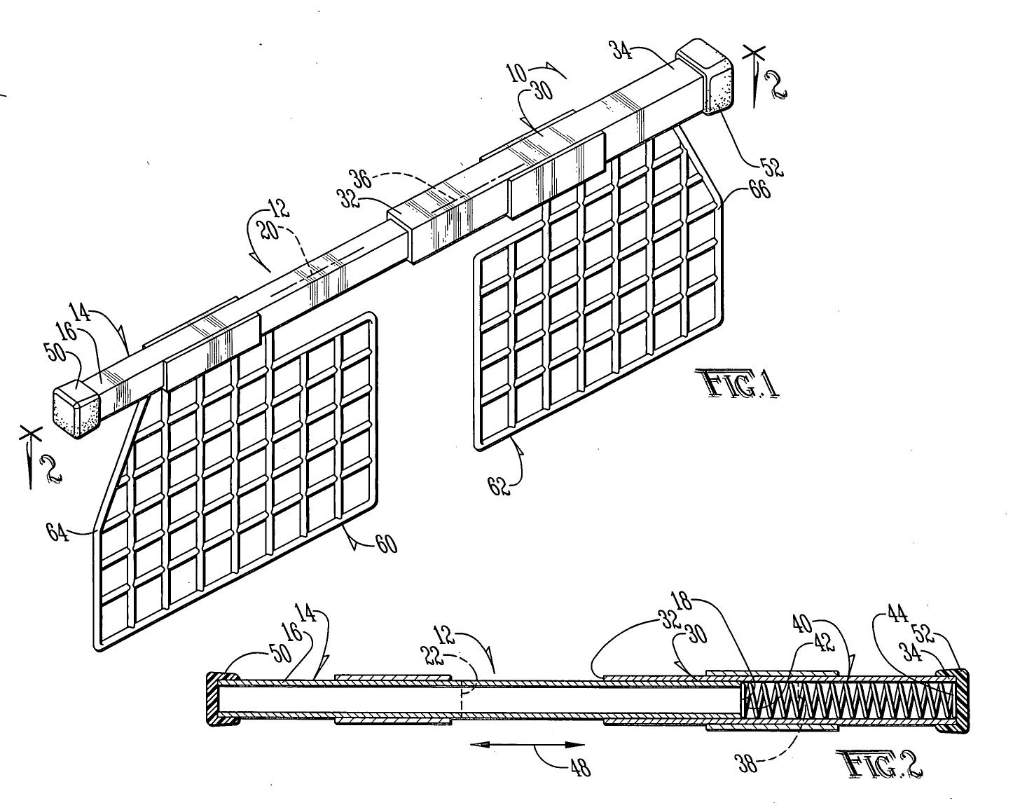

### DETAILED DESCRIPTION OF THE INVENTION

Referring to the figures, it can be understood that the present invention is embodied in a pet barrier 10 for use in a motor vehicle to isolate a pet from the remainder of the interior of the motor vehicle, and especially from the driver. Pet barrier 10 comprises telescoping support pole 12 which will extend across the width dimension of the passenger compartment when the barrier is in use.

Pole 12 includes a first hollow section 14 which has a first end 16, a second end 18 and a longitudinal axis 20 which extends between the first and second ends of first section 14. First section 14 has an outer dimension 22. The pole further includes a second hollow section 30 which has a first end 32, a second end 34 and a longitudinal axis 36 which extends between the first and second ends of second section 30. Second end 30 has an inner dimension 38. Inner dimension 38 of second section 30 is greater than outer dimension 22 of first section 14 so that the first section slidably fits into the second section with the second end of the first section being located inside the second section.

A spring 40 is located in the second section and has a first end 42 abutting second end 18 of first section 14 and a second end 44 abutting second end 34 of second section 30. The spring biases the first section outwardly of the second section in the direction of the longitudinal axis of the second section as indicated by double-headed arrow 48 in FIG. 2. First section moves inwardly and outwardly with respect to the second section so the pole can be mounted on the inside of a motor vehicle as will be understood from the teaching of this disclosure.

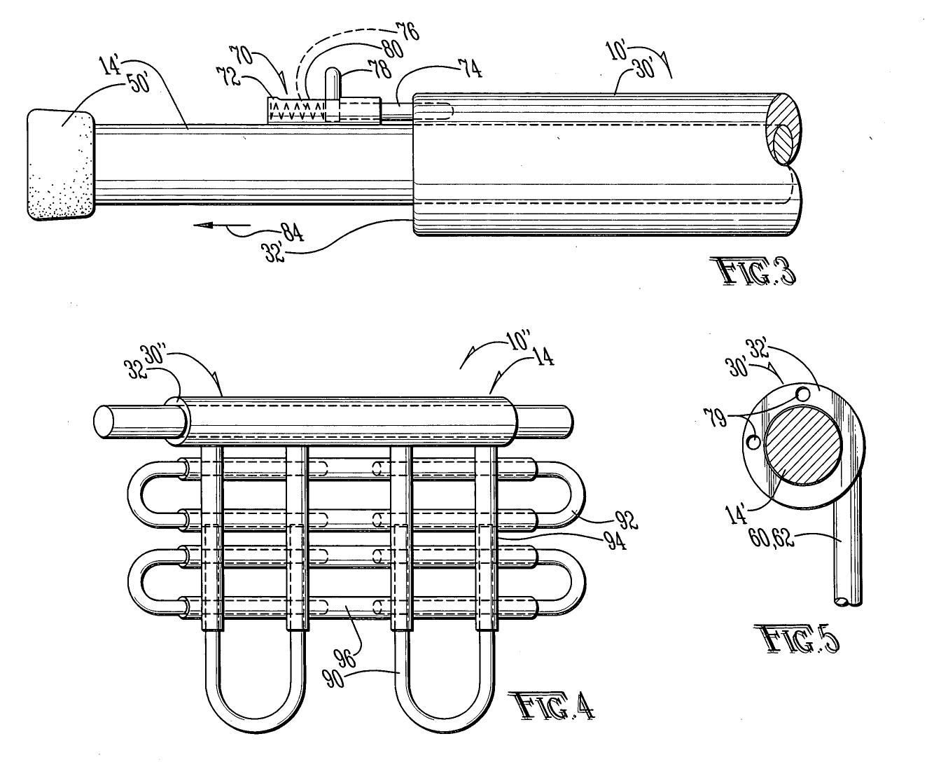

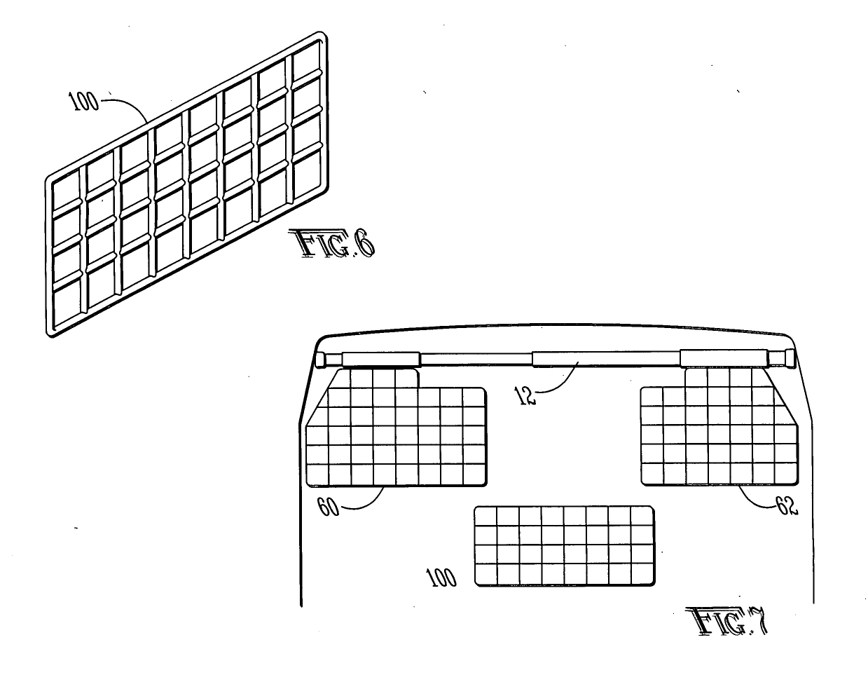

A first end cap 50 is located on the first end of the first section, and a second end cap 52 is located on the second end of the second section. The end caps can be rubber grommets such as shown in FIG. 3 for end cap 50′. A first screen 60 is mounted on first section 14 and a second screen 62 is mounted on second section 30. The screens can include angled sections, such as sections 64 and 66, if desired. More than two screens can be included with the pet barrier if necessary.

An alternative form of the pet barrier is shown in FIG. 3 as pet barrier 10′ and includes a spring-loaded lock 70 on the first section. Lock 70 has a housing 72 and a bolt element 74 slidably mounted in the housing. A spring 76 engages the bolt to bias the bolt outwardly of the housing. Bolt-accommodating holes 78 are defined in first end 32′ of second section 30′. The bolt is biased toward the holes and will fit into the holes to lock the first section to the second section. A handle 78 on the lock extends though a slot 80 defined in the housing and is used to retract the bolt in direction 84 from engaging the second section to unlock the first section from the second section.

Pet barrier 10′ can be permanently mounted on a vehicle and section 30′ rotated with respect to section 14′ so the screens can be stored adjacent to the roof of the passenger compartment when not in use, yet easily swung back into compartment-dividing position when necessary. Lock 70 is operated to engage one hole 78 to hold the pet barrier in the stored condition, and to engage a second hole 78 to hold the pet barrier in the use orientation.

Another alternative form of the pet barrier is shown in FIG. 4 as pet barrier 10″ and has each of screens 60′ and 62′ including a plurality of looped sections 90 and 92 and sleeves 94 and 96 covering portions of the looped sections. Looped sections 90 are fastened to section 30″ and looped sections 92 are attached to looped sections 90 by means of sleeves 96 whereby the size of the screen can be adjusted by sliding the looped sections in sleeves 96 with respect to looped sections 90.

It is also noted that, while the pet barrier has been disclosed as being useable in the passenger compartment of a vehicle, it can also be used in a cargo area of a vehicle without departing from the scope of the present disclosure. The barrier can be mounted close to the rear of the vehicle or closely adjacent to the front seat of the vehicle, or in any other location as needed. If desired, a separate screen, such as screen 100 shown in FIGS. 6 and 7, can be mounted on the floor of the vehicle to cooperate with the screens of the pet barrier in dividing the space of the vehicle.

Use of the pet barrier can be understood from the teaching of the foregoing disclosure and thus will be only briefly discussed. During storage, the pet barrier can be easily removed from a vehicle by forcing the first section of the support pole into the second section against the bias of the spring. For use, the pole is compressed in the just-described manner, and located in the vehicle where desired. The first and second sections are released and extend until the ends of the sections frictionally engage the inside surfaces of the vehicle. The screens then extend pendently downward toward the seat of the vehicle and divide the passenger compartment. A pet can be located so that the screens are interposed between the pet and the remainder of the passenger compartment to isolate that pet from the passengers and from the driver. If a lock is used, the lock is operated to permit the above-described operations and then re-engaged to hold one section of the pole stationary with respect to the other section of the pole.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A pet barrier for use in a motor vehicle comprising:
A) telescoping support pole which includes
(1) a first hollow section having
(a) a first end,
(b) a second end,
(c) a longitudinal axis which extends between the first and second ends of the first section, and
(d) an outer dimension, and
(2) a second hollow section having
(a) a first end,
(b) a second end,
(c) a longitudinal axis which extends between the first and second ends of the second section, and
(d) an inner dimension, the inner dimension of the second section being greater than the outer dimension of the first section so that the first section slidably fits into the second section with the second end of the first section being located inside the second section;
B) a spring located in the second section and having a first end abutting the second end of the first section and a second end abutting the second end of the second section, the spring biasing the first section outwardly of the second section in the direction of the longitudinal axis of the second section;
C) a first end cap on the first end of the first section;
D) a second end cap on the second end of the second section;
E) a first screen mounted on the first section; and
F) a second screen mounted on the second section.

2. The pet barrier defined in claim 1 further including a lock on the first section and a lock-accommodating portion on the second section.

3. The pet barrier defined in claim 2 wherein the lock is spring loaded to be biased into a locking condition to lock the first section to the second section.

4. The pet barrier defined in claim 1 wherein the first and second end caps include rubber grommets.

5. The pet barrier defined in claim 1 wherein each of the screens includes a plurality of looped sections and sleeves covering portions of the looped sections.

6. The pet barrier defined in claim 1 further including a third screen.
